(19) United States
(12) Patent Application Publication
(10) Pub. No.: US 2009/0162035 A1
(43) Pub. Date: Jun. 25, 2009

(54) PLAYBACK METHOD AND PLAYBACK SYSTEM OF CONTENTS

(76) Inventors: Tatsuya NARAHARA, Kanagawa (JP); Shunji Yoshimura, Tokyo (JP); Sho Murakoshi, Tokyo (JP)

Correspondence Address: FROMMER LAWRENCE & HAUG LLP, 745 FIFTH AVENUE, NEW YORK, NY, 10151, US

(21) Appl. No.: 12/339,454

(22) Filed: Dec. 19, 2008

(30) Foreign Application Priority Data
Dec. 21, 2007 (JP) P2007-329623

(51) Int. Cl. H04N 5/91

(52) U.S. Cl. 386/124; 386/E05.001

(57) ABSTRACT

A playback method of contents which plays back contents by a portable-type player connected to a recorder recording/playing back contents provided from the outside through a network is disclosed. The method includes the steps of transmitting data indicating contents satisfying a request to the player through the network by the recorder when receiving the request of playing back contents from the player through the network, requesting the recorder to transmit data of a selected content to the player through the network according to data indicating the selected content by the player when selecting the target content from the transmitted data, and playing back data of the transmitted content when data of the target content is transmitted from the recorder to the player through the network according to the request.

### CROSS REFERENCE TO RELATED APPLICATIONS

The present invention contains subject matter related to Japanese Patent Application JP 2007-329623 filed in the Japanese Patent Office on Dec. 21, 2007, the entire contents of which being incorporated herein by reference.

### BACKGROUND OF THE INVENTION

1. Field of the Invention

The invention relates to a playback method and a playback system of contents.

2. Description of the Related Art

A hard disc recorder is becoming common as a video recorder recording TV programs and the like. The hard disc recorder uses a large-capacity hard disc drive as a recording medium thereof. Since the hard disc drive can be randomly accessed, it is possible to select and play back an arbitrary program quickly from plural recorded programs as well as to play back only part of the arbitrary program. It is also possible to play back past part of a certain program or another program while recording the program.

On the other hand, a method of downloading moving picture data is downloaded through a network and the like to be played back and a method of performing streaming playback of moving pictures are also becoming common. As video players for such methods, a personal computer, a portable video player, a cellular phone device and the like are used.

Accordingly, an audio-visual system can be considered, whereby programs recorded by a hard disc recorder at home can be viewed using a portable video player, a cellular phone and the like even at places other than home.

An example of the related art includes JP-A-2007-156804 (Patent Document 1).

### SUMMARY OF THE INVENTION

However, when the above audio and visual system is realized, the following problem occurs. That is, when the program recorded in the hard disc recorder at home is viewed at a place other than home, it is necessary to copy moving picture data thereof into the portable video player once. For example, when a program broadcasted at midnight is timer-recorded in the hard disc recorder at home and the program is viewed at lunchtime in the office, it is necessary to copy the moving picture data into the portable video player once. However, such copy operation is bothersome.

In that point, when the portable video player includes a communication function, or when the cellular phone device is used as a video player, the program recorded in the hard disc recorder at home may be played back in a streaming manner by the portable video player or the cellular phone device, which is easy to be operated. However, in this case, when many programs are recorded in the hard disc recorder at home, it is hard to find a target program among them, which takes a lot of trouble.

The present invention addresses the above-identified problems.

According to an embodiment of the invention, there is provided a playback method of contents which plays back contents by a portable-type player connected to a recorder recording/playing back contents provided from the outside through a network, in which the recorder transmits data indicating contents satisfying a request to the player through the network when receiving the request of playing back contents from the player through the network, in which the player requests the recorder to transmit data of a selected content to the player through the network according to the data indicating the selected content when selecting the target content from the transmitted data, and in which data of the transmitted content is played back when data of the target content is transmitted from the recorder to the player through the network according to the request.

According to the embodiment of the invention, the contents recorded in the recorder can be selected by the portable player and played back in a streaming manner, therefore, it is possible to view the target content at arbitrary time and at an arbitrary place. At this time, all you have to do is select the target content from plural contents recorded in the recorder, therefore, operation is extremely easy as same as the case when playing back the target content at home.

### BRIEF DESCRIPTION OF THE DRAWINGS

FIG. 1 is a system diagram showing the entire configuration of an embodiment of the invention;

FIG. 2 is a system diagram showing a recording system according to an embodiment of the invention;

FIG. 3 is a system diagram showing a playback system according to an embodiment of the invention;

FIG. 4A to FIG. 4E are views showing display examples according to an embodiment of the invention;

FIG. 5A and FIG. 5B are views for explaining an embodiment of the invention; and

FIG. 6 is a view showing a data example for explaining an embodiment of the invention.

### DESCRIPTION OF THE PREFERRED EMBODIMENTS

### (1) Outline of Entire Configuration

### (1-1) Example of System Configuration and Processing

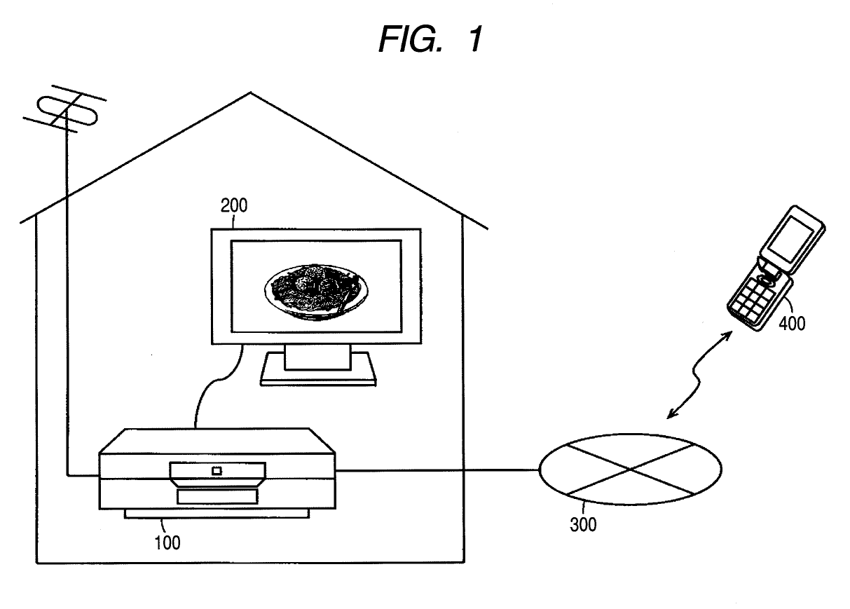

FIG. 1 is a view for explaining an outline of a system according to an embodiment of the invention. This example shows a case in which a hard disc recorder 100 is set up at home as a recording/playback apparatus for TV programs as well as a display 200 is connected to the hard disc recorder 100 as a monitor. A sign 300 denotes a wide area network such as a telephone communication network or Internet, and a sign 400 denotes a portable-type video player, in this case, a cellular phone device.

Though the details of a configuration of the hard disc recorder 100 will be later described, the hard disc recorder 100 has functions of receiving terrestrial digital television broadcasting, BS broadcasting, CS broadcasting and the like, recording and playing back contents, namely, these programs as well as configured to output a signal of a program during recording or during playback to the display 200. Further, the hard disc recorder 100 is connected to a wide range network 300, which is configured to supply a playback signal of the program recorded in the hard disc recorder 100 to the cellular phone device 400 through the wide range network 300 and to play back the program in a streaming manner by the cellular phone device 400.

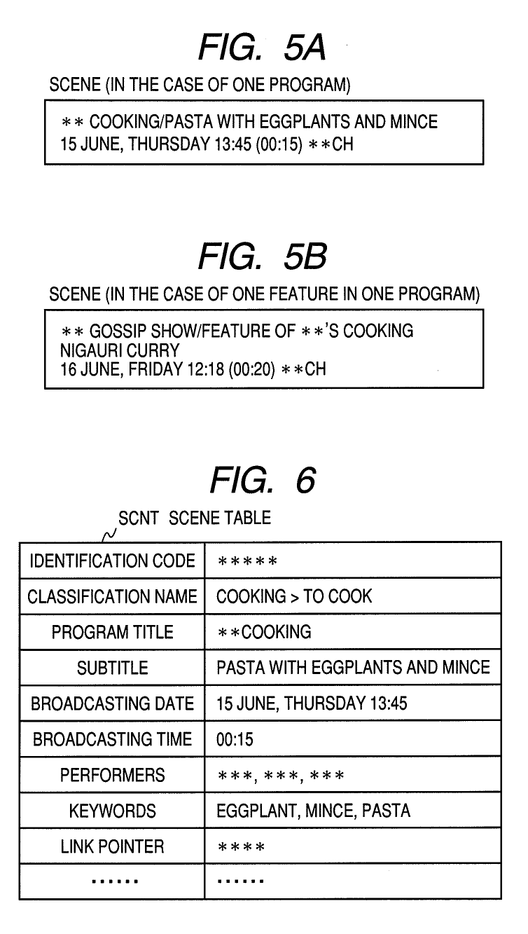

In the case of streaming playback according to an embodiment of the invention, the hard disc recorder 100 records programs according to a “scene” of the program. In this case, the “scene” indicates the whole one program or a part (section) having a meaning by itself such as a specific feature in the program. FIG. 5A shows a case in which one scene indicates the whole one cooking program, and FIG. 5B shows a case in which one scene indicates a feature of cooking in a gossip show.

Since the scene recorded in the hard disc recorder 100 is played back in a streaming manner by the cellular phone device 400, a scene table SCNT as shown in, for example, FIG. 6 is created at a part of an internal hard disc drive (not shown) of the hard disc recorder 100. The scene table SCNT is a list of information related to the program during broadcasting, which is created according to scenes. Through the details of the scene table SCNT will be described later, the table can be created based on EPG, ECG, related data broadcasted with the program during broadcasting, data provided from various data services.

ECG is also called as an electronic content guide, in which meta data of an arbitrary program is associated according to given conditions. As metadata, there are an identification code of a corresponding program, a title (program title), a broadcasting date, broadcasting start time, broadcasting time (time length), a category, performers, other various related information, keywords for search and the like.

The scene table SCNT includes an identification code of a scene, a classification name of a scene, a program title, a subtitle, a broadcasting date, broadcasting time, performers, keywords for search effective for searching the scene (for example, ingredients in the case of cooking), a link pointer indicating a record position (start address of recording) at the time of recording the scene in the hard disc drive, and the like. FIG. 5A, FIG. 5B and FIG. 6 shows a case of the scene of cooking.

### (1-2) Normal Recording

The recording is the same as the case of a normal video recorder, that is, when recording operation is performed with respect to the hard disc recorder 100, or when recording reservation is made in advance by a timer or EPG when the reserved time comes, a program (scene) of a channel selected at this time is recorded in the hard disc drive of the hard disc recorder 100.

When a prescribed operation is performed to the hard disc recorder 100 and the display 200, the program during recording is displayed on the display 200. According to the recording, the scene table SCNT is created.

### (1-3) Normal Playback

The playback is also the same as the case of a normal video recorder, that is, when playback operation is performed with respect to the hard disc recorder 100, a program recorded in the hard disc drive of the hard disc recorder 100 is selected and played back, and the played-back program is displayed on the display 200.

### (1-4) Viewing (Streaming Playback) of a Program by the Cellular Phone Device 400

A case in which a scene “Pasta with eggplants and mince” shown in FIG. 5A is selected and viewed by the cellular phone device 400 in a manner of streaming playback is shown as follows.

That is, in this case, access is performed by the cellular phone device 400 with respect to the hard disc recorder 100 through the wide range network 300, and authentication of the cellular phone device 400 is performed. When the cellular phone device 400 is authenticated by the hard disc recorder 100, the cellular phone device 400 notifies the hard disc recorder 100 of the playback of the recorded program.

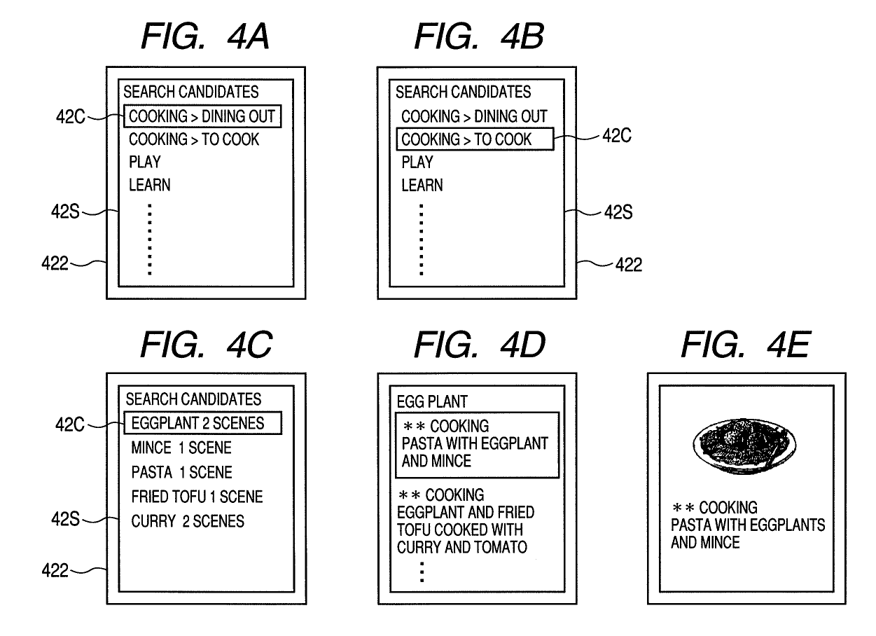

Then, data indicating classification names of the scene tables SCNT created in the hard disc recorder 100 is transmitted from the hard disc recorder 100 to the cellular phone device 400 through the wide range network 300, and the classification names in the scene tables SCNT are displayed in a list as well as a cursor 42C is displayed at the first line of the list on a screen 42S of the cellular phone device 400 as shown in, for example, FIG. 4A. In this case, there is the same classification name in plural scenes, one of these scenes is displayed as a representative. For example, even when there are two scenes belonging to “cooking>to cook”, one of “cooking>to cook”s will be selected and displayed.

Accordingly, cursor keys (not shown) of the cellular phone device 400 is operated to move the cursor 42C to the classification name “cooking>to cook” as shown in, for example, FIG. 4B, and an execution key (not shown) is operated. Then, the selection of the classification name “cooking>to cook” is notified from the cellular phone device 400 to the hard disc recorder 100 through the wide range network 300.

In the hard disc recorder 100, all scene tables SCNT (FIG. 6) including the notified classification name “cooking>to cook” in scene tables SCNT registered in the hard disc drive are selected as well as keywords registered in the scene tables SCNT are transmitted from the hard disc recorder 100 to the cellular phone device 400 through the wide range network 300, as a result, on the screen 42S of the cellular phone device 400, ingredients registered in the scene tables SCNT are displayed in a list from the scene tables SCNT selected by the operation just before as well as the cursor 42C is displayed at the first line of the list as shown in, for example, FIG. 4C.

In this case, dishes using eggplants are desired and the cursor 42C is displayed in a line of “eggplant”, therefore, the execution key is operated in the state of FIG. 4C. Then, the selection of the item “eggplant” is notified from the cellular phone device 400 to the hard disc recorder 100 through the wide range network 300.

In the hard disc recorder 100, data of program names and subtitles of scenes including “eggplant” in keywords in scene tables SCNT of the classification name “cooking>to cook” (FIG. 6) is taken out, and the data is transmitted from the hard disc recorder 100 to the cellular phone device 400 through the wide range network 300. Therefore, on the screen 42S of the cellular phone device 400, program names and subtitles of corresponding scenes in scenes registered in the scene tables SCNT are displayed in a list as well as the cursor 42C is displayed at the first program name and the dish name as shown in, for example, FIG. 4D.

In this case, “pasta with eggplants and mince” is a desired dish and the cursor 42C is displayed at the position thereof, therefore, the execution key is operated in the state of FIG. 4D. Then, the selection of the item of “pasta with eggplants and mince” is notified from the cellular phone device 400 to the hard disc recorder 100 through the wide range network 300.

As a result, in the hard disc recorder 100, the scene of “pasta with eggplants and mince” is selected and the scene is played back based on an address indicated by a link pointer of the scene table SCNT and a playback signal is transmitted from the hard disc recorder 100 to the cellular phone device 400 through the wide range network 300. Therefore, on the screen 42S of the cellular phone device 400, the program of “pasta with eggplants and mince” is played back in a streaming manner and displayed as shown in, for example, FIG. 4E.

According to the above system, the scene (the whole program or a necessary part thereof) recorded in the hard disc recorder 100 can be selected in a hierarchical manner by the cellular phone device 400 to be played back in a streaming manner.

### (2) Configuration Example and Operation of the Hard Disc Recorder 100

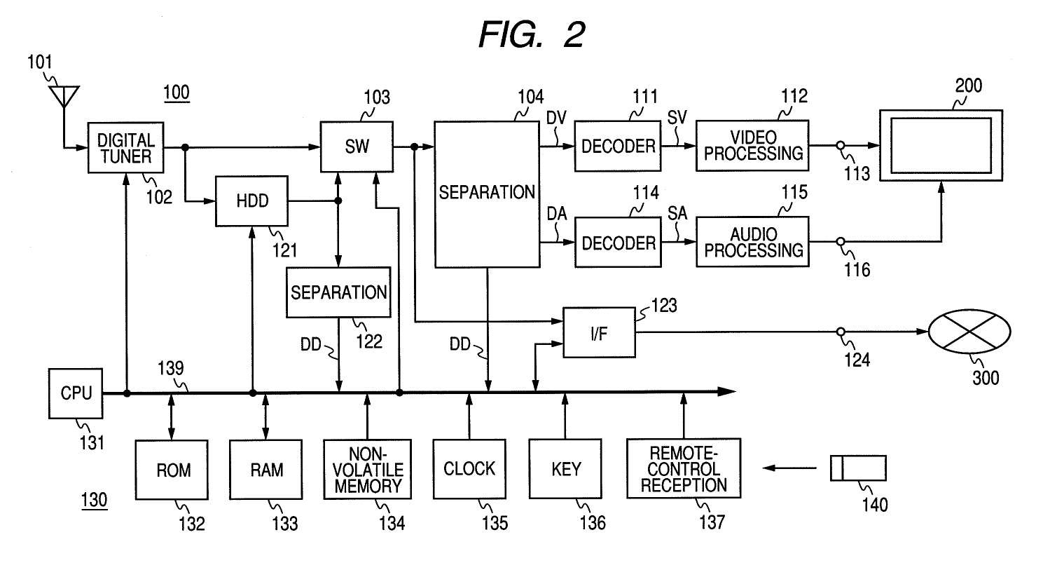

FIG. 2 shows an example of the hard disc recorder 100, an in this example, the hard disc recorder 100 can receive terrestrial digital broadcasting, BS broadcasting and CS broadcasting as well as can record/playback them. That is, digital broadcasting is received by an antenna 101, and a received signal thereof is supplied to a digital tuner 102 and digital data of a target channel is taken out, then, the digital data is supplied to a switching circuit 103.

Additionally, a large-capacity recording medium for recording programs (scenes), in the example, a hard disc drive 121 is provided. An output signal from the digital tuner 102 is supplied for recording to the hard disc drive 121, and an output signal from the hard disc drive 121 (a recording monitor signal or a playback signal) is supplied to a switching circuit 103 as well as supplied to a separation circuit 122 to take out various digital data DD associated with the program, and the digital data DD is supplied to a later described micro computer 130. The operation of the hard disc drive 121 is controlled by the micro computer 130.

Then, the switching circuit 103 is controlled by the micro computer 130, and an output signal from the digital tuner 102 or the hard disc drive 121 is selectively taken out from the switching circuit 103 to be supplied to a separation circuit 104, separated into a digital video signal DV, a digital audio signal DA and digital data DD to be outputted.

The digital video signal DV taken out from the separation circuit 104 is supplied to a decoder circuit 111 and decompressed into a digital video signal of an original size as well as D/A converted into an original analog video signal SV, and the analog video signal SV is variously corrected by a video processing circuit 112 to be taken out at an output terminal 113. The analog video signal SV taken at the output terminal 113 is supplied to the display 200 and displayed as pictures.

The digital audio signal DA taken out from the separation circuit 104 is supplied to a decoder circuit 114 and decompressed into a digital audio signal of an original size as well as D/A converted into an original analog audio signal SA, and the analog audio signal SA is variously corrected by an audio processing circuit 115 to be taken out at an output terminal 116. The analog audio signal SA taken out at the output terminal 116 is supplied to a speaker (not shown) included in the display 200 to be outputted as audio. The digital data DD taken out from the separation circuit 104 is supplied to the microcomputer 130.

Further, the output signal of the switching circuit 103 is supplied to an interface circuit 123, format-converted into a signal format for communication or for distribution to be taken out, and the signal is further supplied to a cellular phone device 400 through an output terminal 124, further, the wide range network 300 as described above. Additionally, data transmitted from the cellular phone device 400 through the wide range network 300 is taken into the micro computer 130 through the output terminal 124, further, through the interface circuit 123.

Furthermore, the microcomputer 130 is provided as a system control circuit. The microcomputer 130 includes a CPU 131, a ROM 132, a RAM 133 and a non-volatile memory 134, and these memories 132 to 134 are connected to the CPU 131 through a system bus 139. In this case, the CPU 131 executes various programs and programs executed by the CPU 131 and fundamental data are written in the ROM 132. The RAM 133 will be a work area when the CPU 131 executes programs, and the non-volatile memory 134 stores various data even when the power is off.

The microcomputer 130 includes a clock circuit 135, various operation keys 136 and a reception circuit 137 for a remote controller (remote operation), which are also connected to the system bus 139. In this case, the clock circuit 135 clocks the current date and the operation keys 136 are for performing fundamental operations directly to the hard disc recorder 100. The reception circuit 137 is paired with a remote-control transmitter 140, and the remote-control transmitter 140 and the reception circuit 137 realize remote control by, for example, infrared light.

Further, control signals are supplied from the microcomputer 130 to the digital tuner 102, the hard disc drive 121, and the switching circuit 103.

According to the configuration, the digital tuner 102, the hard disc drive 121, and the switching circuit 103 are respectively controlled through the microcomputer 130 by operating the operation keys 136 or the remote-control transmitter 140. That is, when the digital tuner 102 is controlled, the reception channel is switched and a target channel is received.

When recording/playback of the hard disc drive 121 is controlled, recording or playback of the program (scene) during receiving is executed and the switching circuit 103 is switched, then, a signal of the program during receiving by the digital tuner 102 or a signal of the program during recording/playback by the hard disc drive 121 is selected and the selected signal is supplied to the separation circuit 104.

Therefore, it is possible to perform reception of a program, the recording of (1-2), and the playback of (1-3). Specific operations and methods at the time of streaming playback will be described later.

### (3) Configuration Example and Operation of the Cellular Phone Device 400

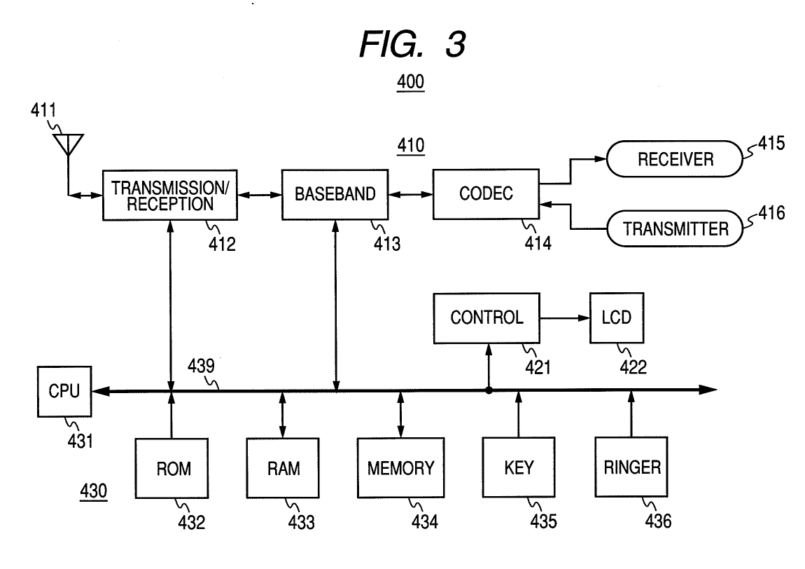

FIG. 3 shows an example of the cellular phone device 400, and in the example, the cellular phone device 400 includes not only original functions as a cellular phone device but also functions as a portable video player as described above, which can play back programs recorded in the portable video recorder 100 in a streaming manner through the wide range network 300.

Specifically, in FIG. 3, a sign 410 denotes a communication circuit. At the time of receiving voice as a cellular phone device, radiowaves from the wide range network 300 is received by a transmission/reception antenna 411 and a reception signal is supplied to a transmission/reception circuit 412 and a baseband digital signal is taken out, which is supplied to a baseband processing circuit 413. In the baseband processing circuit 413, baseband processing at the time of receiving voice is performed with respect to the digital signal supplied thereto to take out a digital audio signal, and the signal is supplied to a codec circuit 414 to be decoded into an original analog audio signal, then, the audio signal is supplied to a receiver 415.

At the time of transmitting voice, an audio signal from the transmitter 416 is supplied to the codec circuit 414 to be encoded into a digital audio signal, and the signal is supplied to the baseband processing circuit 413. Baseband processing at the time of transmission is performed to the signal to be supplied to the transmission/reception circuit 412 to be a transmission signal, and the signal is transmitted to the wide range network 300 through the transmission/reception antenna 411. Accordingly, it is possible to communicate with the other party through the communication circuit 410.

At the time of calling out, when operation keys 435 are operated, transmission/reception of the transmission/reception circuit 412 is permitted as well as data of a telephone number corresponding to the operation of the operation keys 435 is supplied from a later-described microcomputer 430 to the transmission/reception circuit 412 through the baseband processing circuit 413 and transmitted from the transmission/reception antenna 411. Therefore, it is possible to call for the other party.

At the time of calling in, a signal indicating call-in is taken out from the baseband processing circuit 413, and a ringer 436 is driven by the microcomputer 430 based on the signal to notify the call-in. At this time, data such as a telephone number of the other party which gave the call-in is supplied to the display control circuit 421 to be a display signal, and the display signal is supplied to a display, for example a LCD 422 which displays the telephone number and the like of the other party.

Furthermore, the above microcomputer 430 is provided as a system control circuit. The microcomputer 430 includes a CPU 431, a ROM 432, a RAM 433 and a non-volatile memory 434, and these memories 432 to 434 are connected to the CPU 431 through the system bus 439. In this case, the CPU 431 executes various programs, and programs executed by the CPU 431 and fundamental data are written the ROM 432. The RAM 433 will be a work area when the CPU 131 executes programs, and the non-volatile memory 434 stores various data even when the power is off.

Additionally, control signals are supplied to the transmission/reception circuit 412 and the baseband processing circuit 413 from the microcomputer 430 as well as prescribed data is supplied from these circuits to the micro computer 430. Therefore, it is possible to perform call-out, call-in and voice communication as described above. Specific operations and methods at the time of streaming playback will be described later.

### (4) Example of the Scene Table SCNT

FIG. 6 shows an example of the scene table SCNT. The scene table SCNT is formed by being associated with the recording to a program in order to play back a scene recorded in the hard disc recorder 100 in a streaming manner by the cellular phone device 400 as described above.

The scene table SCNT includes an identification code, a classification name of a scene, a program name, a subtitle, a broadcasting date, broadcasting time (length), performers, keywords for search, and a pointer indicating a recording position when the scene is recorded in the hard disc drive.

Here, the identification code is unique data for identifying the scene table SCNT, the classification name is an item name in the most significant classification at the time of selecting a target scene as shown in, for example FIG. 4A. The scene table SCNT of FIG. 6 shows a case of the scene of cooking. Additionally, the program name is a program name of the recorded program, the subtitle is a theme of a program given by the side of a broadcasting station, and the scene table SCNT of FIG. 6 shows a case of a pasta dish using eggplants and mince.

The broadcasting date and the broadcasting time (length) show the time and the time length when the program is broadcasted, and the performers show main performers, guest performers and the like of the program. The keywords show data for search which is effective for searching a corresponding scene, that is, data of ingredients used in the cooking and the like in the case of cooking as shown in FIG. 6. In addition, the link pointer is a pointer indicating a recording position (start address of the recording) when the scene corresponding to the scene table SCNT was recorded in the hard disc drive 121.

### (5) Viewing of the Program by the Cellular Phone Device 400 (Streaming Playback)

Hereinafter, the case in which the scene “Pasta with eggplants and mince” shown in FIG. 5A is selected and viewed by the cellular phone device 400 according to the streaming playback will be explained.

That is, when the scene recorded in the hard disc recorder 100 is played back in a streaming manner by the cellular phone device 400, as described in (1-4), the cellular phone device 400 performs call-out to be connected to the hard disc recorder 100, after that, the cellular phone device 400 is authenticated by operating the operation keys 435. When the cellular phone device 400 is authenticated by the hard disc recorder 100, the playback of the recorded program is notified from the cellular phone device 400 to the hard disc recorder 100 by operating the operation keys 435.

Then, in the hard disc recorder 100, data indicating the classification name of the scene table SCNT created in the hard disc drive 121 is collected from respective scene tables SCNT, and the data is transmitted from the hard disc recorder 100 to the cellular phone device 400 through the wide range network 300. At this time, when there is the same classification name in plural scenes, one of these scenes is selected as a representative, and data having the same classification name is not transmitted repeatedly.

Therefore, for example, as shown in FIG. 4A, a list of classification names are displayed on the screen 42S of the cellular phone device 400 as well as the cursor 42C is displayed at the first line of the list as shown in, for example, FIG. 4A.

Here, a cursor key in the operation keys 435 of the cellular phone device 400 is operated to move the cursor 42C to the classification name “cooking>to cook” as shown in, for example, FIG. 4B, and the execution key is operated. Then, the selection of the classification name “cooking>to cook” is notified from the cellular phone device 400 to the hard disc recorder 100 through the wide range network 300.

In the hard disc recorder 100, all scene tables SCNT including the notified classification name “cooking>to cook” in scene tables SCNT registered in the hard disc drive are selected as well as all identification codes belonging to the classification name are stored in, for example, the RAM 133 once, even when plural scenes belong to the same classification name.

Further, in the hard disc recorder 100, keywords registered in the scene tables SCNT including the notified classification name “cooking>to cook”, in this case, data indicating ingredients is transmitted from the hard disc recorder 100 to the cellular phone device 400 through the wide range network 300, as a result, ingredients and the number of dishes using the ingredients registered in the scene tables SCNT are displayed in a list and the cursor 42C is displayed at the first line of the list on the screen 42S of the cellular phone device 400 as shown in, for example, FIG. 4C, based on the scene tables SCNT selected by the operation just before.

In this case, dishes using eggplants are desired and the cursor 42C is displayed in a line of “eggplant”, therefore, the execution key of the operation keys 435 is operated in the state of FIG. 4C. Then, the selection of the item “eggplant” is notified from the cellular phone device 400 to the hard disc recorder 100 through the wide range network 300.

In the hard disc recorder 100, data of scene tables SCNT of scenes whose identification codes are stored in the RAM 133 as well as data of program names and subtitles of scenes including “eggplant” in ingredients are taken out, and the data is transmitted from the hard disc recorder 100 to the cellular phone device 400 through the wide range network 300. Therefore, on the screen 42S of the cellular phone device 400, program names and subtitles of corresponding scenes in scenes registered in the scene tables SCNT are displayed in a list as well as the cursor 42C is displayed at the first program name and the dish name as shown in, for example, FIG. 4D.

In this case, “pasta with eggplants and mince” is a desired dish and the cursor 42C is displayed at the position thereof, therefore, the execution key of the operation keys 435 is operated in the state of FIG. 4D. Then, the selection of the item of “pasta with eggplants and mince” is notified from the cellular phone device 400 to the hard disc recorder 100 through the wide range network 300.

As a result, in the hard disc recorder 100, the scene table SCNT of “pasta with eggplants and mince” shown in FIG. 6 is selected and the scene is played back based on an address indicating a link pointer of the scene table SCNT in the hard disc drive 121 and a playback signal is transmitted from the interface circuit 123 to the cellular phone device 400 through the wide range network 300. Therefore, on the screen 42S of the cellular phone device 400, the program of “pasta with eggplants and mince” is played back in a streaming manner and displayed as shown in, for example, FIG. 4E.

According to the above system, the scene (the whole program or a necessary part thereof) recorded in the hard disc recorder 100 can be selected in a hierarchical manner by the cellular phone device 400 to be played back in a streaming manner.

### (6) Summary

According to the above system, the scene recorded in the hard disc recorder 100 can be selected by the cellular phone device 400 and played back in a streaming manner, therefore, it is possible to record a target program by the hard disc recorder 100 and to view the program at arbitrary time and an arbitrary place using the cellular phone device 400. At this time, it is not necessary to copy the scene recorded in the hard disc recorder 100 in the cellular phone device 400 and all you have to do is to select a target scene of plural scenes recorded in the hard disc recorder 100, therefore, the operation will be almost the same as the case in which the target scene is played back using the display 200 at home, which is extremely simple.

Additionally, since the target and the scene are selected in a hierarchical manner, the selection is easy. Further, the CPU 431 used in the cellular phone device 400 generally has a lower ability than the CPU 131 used in the hard disc recorder 100, however, data in respective hierarchies is managed and processed by the hard disc recorder 100, therefore, the load of the CPU 431 can be reduced.

### (7) Others

The scene tables SCNT can apply an XML format instead of the table format as shown in FIG. 6 and respective items can be shown by tags. It is also preferable that keywords in the scene table SCNT can be created or added, for example, after program names and subtitles are analyzed in the hard disc recorder 100.

Furthermore, it is also preferable that the whole one program is recorded and after that, a part of the program is remained as a scene according to conditions previously set by the viewer as shown in, for example, FIG. 5B. In addition, the recording reservation of programs in the hard disc recorder 100 can be set from the cellular phone device 400. Further, the case that the TV station broadcasts programs was explained in the above description, however, the invention can be also applied to a case that a provider and the like deliver contents at given time.

It should be understood by those skilled in the art that various modifications, combinations, sub-combinations and alterations may occur depending on design requirements and other factors insofar as they are within the scope of the appended claims or the equivalents thereof.

What is claimed is:

1. A playback method of contents which plays back contents by a portable-type player connected to a recorder recording/playing back contents provided from the outside through a network, the method comprising the steps of:
transmitting data indicating contents satisfying a request to the player through the network by the recorder when receiving the request of playing back contents from the player through the network;
requesting the recorder to transmit data of a selected content to the player through the network according to data indicating the selected content by the player when selecting the target content from the transmitted data; and
playing back data of the transmitted content when data of the target content is transmitted from the recorder to the player through the network according to the request.

2. A playback system of contents comprising:
a recorder recording/playing back contents provided from the outside; and
a portable-type player connected to the recorder through a network,
wherein the recorder transmits data indicating contents satisfying a request to the player through the network when receiving the request of playing back contents from the player through the network,
wherein the player requests the recorder to transmit data of a selected content to the player through the network according to data indicating the selected content when selecting the target content from the transmitted data, and
wherein data of the transmitted content is played back when data of the target content is transmitted from the recorder to the player through the network according to the request.
